(19) United States
(12) Patent Application Publication
(10) Pub. No.: US 2014/0029529 A1
(43) Pub. Date: Jan. 30, 2014

(54) ASYMMETRIC RADIO ACCESS NETWORK (RAN) RESOURCE ALLOCATION IN RAN SHARING ARRANGEMENT

(71) Applicant: QUALCOMM Incorporated, San Diego, CA (US)

(72) Inventors: Aleksandar Gogic, La Jolla, CA (US); Gavin Bernard Horn, La Jolla, CA (US)

(73) Assignee: QUALCOMM Incorporated, San Diego, CA (US)

(21) Appl. No.: 13/949,804

(22) Filed: Jul. 24, 2013

Related U.S. Application Data
(60) Provisional application No. 61/675,684, filed on Jul. 25, 2012.

(51) Int. Cl. H04W 72/08

(52) U.S. Cl. CPC H04W 72/08
USPC 370/329

(57) ABSTRACT

Certain aspects of the present disclosure provide techniques and apparatuses for allocating resources in a shared radio access network (RAN). As described herein, a RAN element (e.g., base station) may allocate shared RAN resources (e.g., radio bearers) between two or more RAN sharing partners (e.g., PLMNs). A method generally includes maintaining a breakdown of RAN resources committed to each of the partners, assessing excess capacity of the RAN resources committed to each of the partners and overall spare capacity of the RAN resources, and allocating the RAN resources in accordance with the assessments and the relationship.

### CLAIM OF PRIORITY UNDER 35 U.S.C. §119

This application claims benefit of U.S. Provisional Patent Application Ser. No. 61/675,684, filed 25 Jul. 2012, which is herein incorporated by reference in its entirety.

### BACKGROUND

1. Field

Certain aspects of the disclosure relate generally to wireless communications systems and, more particularly, to techniques to allocate resources in a shared radio access network (RAN).

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{N_{T}, N_{R}}. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

As growth of wireless data services continues, new radio access technologies are being developed and deployed, and cell density is constantly increasing to cope with the increasing demand. The expense of keeping up with demand growth is exacerbated by falling prices for the services. As a result, radio access network (RAN) sharing arrangements between two or more partners are viewed as one approach to reducing the associated financial risks of investments of capital for these deployments and for operating costs.

### SUMMARY

Certain aspects of the present disclosure provide a method of allocating radio access network (RAN) resources in accordance with a relationship between partners. The method generally includes maintaining a breakdown of RAN resources committed to each of the partners, assessing excess capacity of the RAN resources committed to each of the partners and overall spare capacity of the RAN resources, and allocating the RAN resources in accordance with the assessments and the relationship.

Certain aspects of the present disclosure provide an apparatus for allocating radio access network (RAN) resources in accordance with a relationship between partners. The apparatus generally includes means for maintaining a breakdown of RAN resources committed to each of the partners, means for assessing excess capacity of the RAN resources committed to each of the partners and overall spare capacity of the RAN resources, and means for allocating the RAN resources in accordance with the assessments and the relationship.

Certain aspects of the present disclosure provide an apparatus for allocating radio access network (RAN) resources in accordance with a relationship between partners. The apparatus generally includes at least one processor. The at least one processor is generally configured to maintain a breakdown of RAN resources committed to each of the partners, assess excess capacity of the RAN resources committed to each of the partners and overall spare capacity of the RAN resources, and allocate the RAN resources in accordance with the assessments and the relationship.

Certain aspects of the present disclosure provide a computer-program product for allocating radio access network (RAN) resources in accordance with a relationship between partners. The computer-program product generally comprises a non-transitory computer-readable medium having code stored thereon, the code executable by one or more processors for maintaining a breakdown of RAN resources committed to each of the partners, assessing excess capacity of the RAN resources committed to each of the partners and overall spare capacity of the RAN resources, and allocating the RAN resources in accordance with the assessments and the relationship.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, according to aspects of the present disclosure.

FIG. 2 is a block diagram of a communication system, according to aspects of the present disclosure.

FIG. 3 illustrates exemplary base station that schedules RAN resources, according to aspects of the subject disclosure.

FIG. 4 illustrates an example of mapping of radio bearers in a wireless communication system, according to aspects of the disclosure.

FIG. 5 illustrates an example of packet queuing principles involving multiple QoS classes, according to aspects of the present disclosure.

FIG. 6 illustrates an example of sharing RAN resources, according to aspects of the present disclosure.

FIG. 7A illustrates example of one-time or infrequent operations for determining a relationship between partners and configuring the RAN resource in accordance with the relationship, according to aspects of the present disclosure.

FIG. 7B illustrates example bearer admission operations, according to aspects of the present disclosure.

FIG. 7C illustrates example packet scheduling operations, according to aspects of the present disclosure.

FIG. 7D illustrates example operations for apportioning failed QoS incidents, according to aspects of the present disclosure.

FIG. 8 illustrates example operations performed by a RAN element, according to aspects of the present disclosure.

### DETAILED DESCRIPTION

Certain aspects of the present disclosure provide apparatuses and techniques for allocating RAN resources based on a relationship between two or more partners sharing RAN resources. As described above, RAN sharing arrangements are one approach to reducing the financial burden of developing and deploying new radio access technologies. According to aspects of the present disclosure, there may be an asymmetric financial commitment in the shared RAN resources between two or more partners sharing RAN resources. Thus, there may be a need to allocate and manage shared resources, while allowing flexibility in the implementation between the partners.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

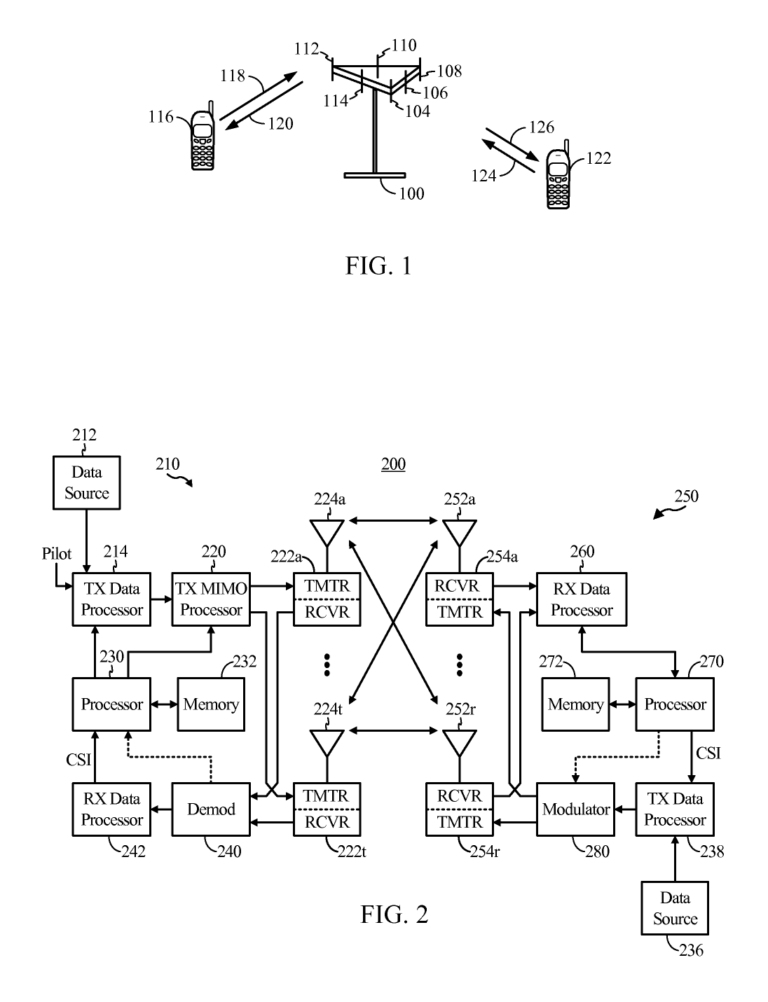

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

According to certain aspects, an AT 116 may be in communication with an AP 100 by means of a radio interface having a radio bearer. Further, additional APs 100 may be inter-connected with each other by means of an interface known as X2, and to a network node, such as an Enhanced Packet Core (EPC) node, by means of an S1 interface.

An access point may be a fixed station used for communicating with the terminals and may also be referred to as a Node B, an evolved Node B (eNB), an eNodeB, or some other terminology. An access terminal may also be called a user equipment (UE), a wireless communication device, wireless terminal, access terminal, or some other terminology.

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

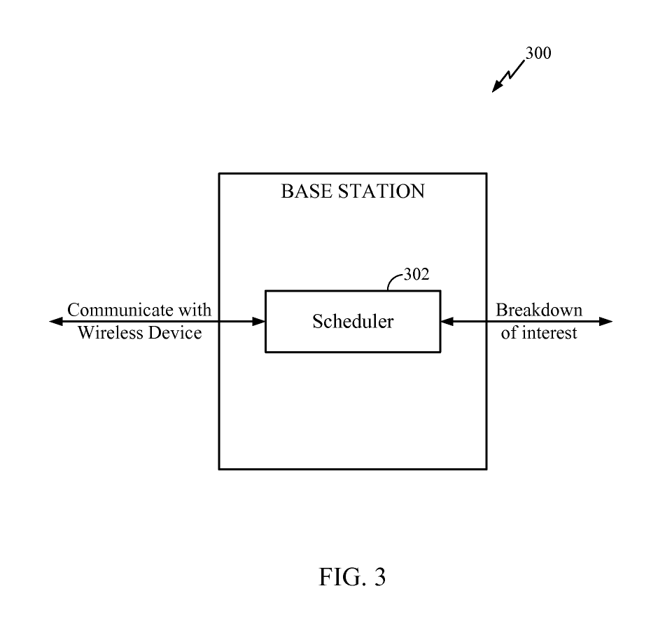

According to certain aspects of the present disclosure, the transmitter system 210 includes additional components for operating in a wireless communications network, as described herein. Specifically, the transmitter system 210 may be configured as a base station as shown in FIG. 3. As will be described in more detail herein, the transmitter system 210 may be configured to allocate and/or schedule RAN resources based on a relationship between RAN sharing partners.

According to certain aspects, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In an aspect, Logical Traffic Channels comprises a Dedicated Traffic Channel (DTCH) which is a Point-to-point bi-directional channel, dedicated to one UE, for the transfer of user information. Also, a Multicast Traffic Channel (MTCH) is a Point-to-multipoint DL channel for transmitting traffic data.

According to certain aspects, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

For the purposes of the present document, the following abbreviations apply:

ACK Acknowledgement

AM Acknowledged Mode

AMD Acknowledged Mode Data

ARQ Automatic Repeat Request

BCCH Broadcast Control CHannel

BCH Broadcast CHannel

BW Bandwidth

C— Control—

CB Contention-Based

CCE Control Channel Element

CCCH Common Control CHannel

CCH Control CHannel

CCTrCH Coded Composite Transport Channel

CDM Code Division Multiplexing

CF Contention-Free

CP Cyclic Prefix

CQI Channel Quality Indicator

CRC Cyclic Redundancy Check

CRS Common Reference Signal

CTCH Common Traffic CHannel

DCCH Dedicated Control CHannel

DCH Dedicated CHannel

DCI Downlink Control Information

DL DownLink

DRS Dedicated Reference Signal

DSCH Downlink Shared Channel

DSP Digital Signal Processor

DTCH Dedicated Traffic CHannel

E-CID Enhanced Cell IDentification

EPS Evolved Packet System

FACH Forward link Access CHannel

FDD Frequency Division Duplex

FDM Frequency Division Multiplexing

FSTD Frequency Switched Transmit Diversity

HARQ Hybrid Automatic Repeat/request

HW Hardware

IC Interference Cancellation

L1 Layer 1 (physical layer)

L2 Layer 2 (data link layer)

L3 Layer 3 (network layer)

LI Length Indicator

LLR Log-Likelihood Ratio

LSB Least Significant Bit

MAC Medium Access Control

MBMS Multimedia Broadcast Multicast Service

MCCH MBMS point-to-multipoint Control Channel

MMSE Minimum Mean Squared Error

MRW Move Receiving Window

MSB Most Significant Bit

MSCH MBMS point-to-multipoint Scheduling CHannel

MTCH MBMS point-to-multipoint Traffic CHannel

NACK Non-Acknowledgement

PA Power Amplifier

PBCH Physical Broadcast CHannel

PCCH Paging Control CHannel

PCH Paging CHannel

PCI Physical Cell Identifier

PDCCH Physical Downlink Control CHannel

PDU Protocol Data Unit

PHICH Physical HARQ Indicator CHannel

PHY PHYsical layer

PhyCH Physical CHannels

PMI Precoding Matrix Indicator

PRACH Physical Random Access Channel

PSS Primary Synchronization Signal

PUCCH Physical Uplink Control CHannel

PUSCH Physical Uplink Shared CHannel

QoS Quality of Service

RACH Random Access CHannel

RB Resource Block

RLC Radio Link Control

RRC Radio Resource Control

RE Resource Element

RI Rank Indicator

RNTI Radio Network Temporary Identifier

RS Reference Signal

RTT Round Trip Time

Rx Receive

SAP Service Access Point

SDU Service Data Unit

SFBC Space Frequency Block Code

SHCCH SHared channel Control CHannel

SNR Signal-to-Interference-and-Noise Ratio

SN Sequence Number

SR Scheduling Request

SRS Sounding Reference Signal

SSS Secondary Synchronization Signal

SU-MIMO Single User Multiple Input Multiple Output

SUFI SUper Field

SW Software

TA Timing Advance

TCH Traffic CHannel

TDD Time Division Duplex

TDM Time Division Multiplexing

TFI Transport Format Indicator

TPC Transmit Power Control

TTI Transmission Time Interval

Tx Transmit

U— User—

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

VOIP Voice Over Internet Protocol

MBSFN multicast broadcast single frequency network

MCH multicast channel

DL-SCH downlink shared channel

PDCCH physical downlink control channel

PDSCH physical downlink shared channel

### Shared RAN Element

FIG. 3 illustrates a base station 300 for wireless communications according to certain aspects of the present disclosure. While certain aspects of the disclosure are discussed in regards to the base station 300, it is understood that other suitable communications apparatuses are contemplated, such as base stations of macrocell, femtocell, picocell, an access point, a relay node, a mobile base station, a portion thereof, and/or substantially any wireless device that transmits signals to one or more disparate devices in a wireless network.

According to certain aspects, the base station 300 (which may be referred to hereinafter as a shared RAN element or RAN element) generally includes, among other components, for example, as illustrated in FIG. 2, a scheduler 302. The scheduler 302 may receive a breakdown of interest of shared RAN resources from, for the example, the network and/or individual RAN sharing partners. Based on this breakdown, the scheduler 302 of the base station may allocate RAN resources, and communicate with one or more wireless devices (e.g., receiver 250 of FIG. 2).

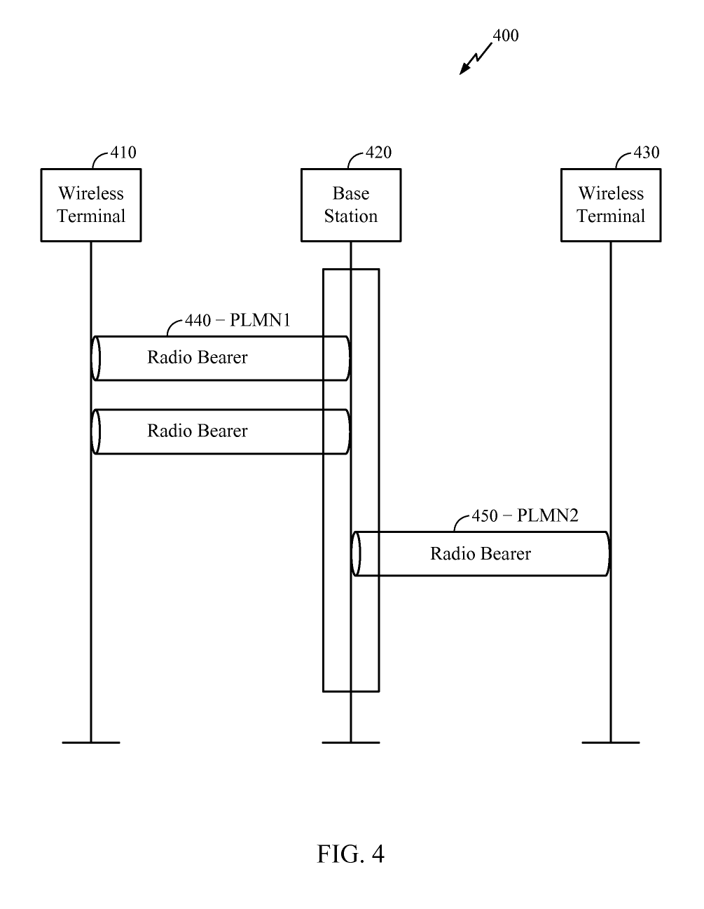

FIG. 4 illustrates an example mapping 400 of radio bearers in a shared RAN arrangement, according to certain aspects of the disclosure. Generally, a bearer is defined as a packet flow with a defined Quality of Service (QoS) between a base station and a user equipment. A plurality of radio bearers 440, 450 provide one or more data flows between one or more wireless terminals 410, 430 (e.g., receiver 250 of FIG. 2) and the base station 420 (e.g., base station 300 of FIG. 3, transmitter 210 of FIG. 2). The base station may know the identity of each of the bearers under its control, for example, as belonging to the specific public land mobile network (PLMN) involved in the RAN sharing arrangement. For example, radio bearers 440 in FIG. 4 may belong to PLMN1, while radio bearer 450 may belong to PLMN2.

As described herein, two or more partners (e.g., PLMNs) may share RAN resources (e.g., radio bearers) pursuant to a sharing arrangement. Sharing partners may negotiate details of the implementation of their RAN sharing partnership. While each partnership arrangement may be relatively precise in terms of a RAN sharing agreement, each separate RAN partnership agreement between two or more partners may vary. For example, a one type of RAN sharing agreement may include a 60/40 split between partners while another type of RAN sharing agreement may include a 80/20 split. RAN sharing agreements may offer other forms of flexibility, including the manner in which a scheduler handles QoS failure incidences, which will be discussed in more detail herein.

A BS may have a limited amount of RAN resources including radio bearers 440 and 450. Using aspects of the present disclosure, the BS may allocate RAN resources to the partners (e.g., allocate radio bearers to PLMNs), based at least in part, on the sharing arrangement.

For example, wireless terminal 410 may be associated with a first RAN sharing partner (e.g., PLMN1) and wireless terminal 430 may be associated with a second RAN sharing partner (e.g., PLMN2). Based on the sharing agreement, the base station 420 may allocate a portion of its available resources, e.g., radio bearers 440, to the first RAN sharing partner and another portion of its available resources, e.g., radio bearer 450 to the second RAN sharing partner. According to aspects, the RAN resources may be apportioned proportional to each partners' financial interest in the shared RAN. While only two wireless terminals and two PLMNs are illustrated in FIG. 4, aspects of the present disclosure may be extended to allocate resources between any number of RAN sharing partners, each of which may have, at any given time, zero or more wireless terminals being served by a shared base station 420.

### Asymmetric RAN Resource Allocation

As discussed above, certain aspects of the present disclosure provide techniques for flexibly allocating resources between two or more RAN sharing partners. Base station 300 of FIG. 3 may be configured to allocate resources based on a relationship between partners sharing RAN resources.

As described herein, a BS (BS 300 of FIG. 3, BS 420 of FIG. 4) may determine a relationship between partners (e.g., PLMNs). The relationship may define how shared RAN resources (e.g., radio bearers) are allocated between the partners. A BS may allocate RAN resources in accordance with the determined relationship between RAN sharing partners, an excess capacity of the RAN resources committed to each of the RAN sharing partners, and an overall spare capacity of the RAN resources.

According to aspects of the present disclosure, at full or nearly-full capacity, RAN resources (e.g., radio bearers) may be shared between, for example, two RAN sharing partners proportional to each partner's financial interest in a joint venture (JV). Network sharing partners may have an asymmetric interest in the JV, in which common RAN resources are shared between a “primary” (P) partner and a “secondary” (S) (non-primary) partner. For example, the primary partner may have a 60% interest in the RAN resources, and the secondary partner may have an interest in the remaining 40%. Each of the partners may own and manage its own core network (e.g., Enhanced Packet Core, (EPC)) infrastructure independently from the other.

According to aspects, the RAN resources may not be subject to a strict physical partition. Instead, the BS may evaluate (e.g., assess and/or determine) the spare capacity of RAN resources committed to each of the RAN sharing partners. Additionally, the BS may evaluate (e.g., assess and/or determine) the overall spare capacity of the RAN resources. Taking the spare capacity of the RAN resources committed to each of the partners and the overall spare capacity of the RAN resources into account, the BS may flexibly allocate RAN resources to one or more of the partners.

For example, it may be determined that a RAN sharing partner, using all of its allocated resources, desires more RAN resources. If excess RAN resources remain, the BS may allocate them (or a portion of the excess RAN resources) to the partner in need.

Using Partners P and S from the above example, it may be determined that Partner P, with a 60% interest in the RAN resources, is using its allocated share of RAN resources and desires more RAN resources. When Partner S is not using the entirety of its allocated 40% of RAN resources, excess RAN resources may exist. In an effort to more effectively utilize RAN resources, the excess RAN resources (or a portion of the excess resources) may be allocated to Partner P. In this way, the RAN element may flexibly allocate RAN resources using the excess capacity of resources committed to each partner and the overall spare capacity of the resources.

As a one-time or infrequent operation, the shared RAN element (e.g., BS 300 of FIG. 3, BS 420 of FIG. 4) may be given information about the breakdown in interest of RAN resources between the RAN sharing partners, so that it may assist in resource management operations. Using the above example, the BS may be given a 60/40 breakdown in the JV interests between Partners P and S, respectively.

As will be described in more detail herein, the resource management operations performed by BS 300 include bearer admission decisions for the partners (e.g., allocation of a new bearer) and radio resource scheduler decisions.

The shared BS (e.g., BS 300) may routinely account for resource management operations for Partners P and S separately. For example, BS 300 may account for admitting a bearer (e.g., IP flow) belonging to Partner P or S. Similarly, when performing scheduling operations, BS 300 may account for scheduling transmission of IP packets belonging to Partner P or S separately.

At times of low traffic load, for example, below capacity of BS 300, new radio bearers may be admitted on the basis of overall resource availability (e.g., JV interest may not be taken into consideration). Similarly, radio resource scheduling may or may not take into consideration the JV interest breakdown of Partners P and S. However, since traffic load is low, such scheduler decisions result in comfortably meeting QoS objectives for all radio bearers belonging to either of the two partners.

At times of high traffic load, for example, at or near the capacity of BS 300, a new bearer may be admitted by taking into consideration the JV interest of each of the RAN sharing partners. If admission of a new bearer belonging to Partner S would result in a projected imbalance of RAN resource consumption in excess of Partner S's proportional interest (augmented by a margin of tolerance), the new bearer may not be admitted by BS 300. Otherwise, the new bearer may be admitted. Similarly, a new bearer for Partner P may be admitted if it would not result in a projected imbalance of RAN resource consumption in excess of Partner P's proportional interest (augmented by a margin of tolerance).

For radio resource scheduling, BS 300 may take into consideration the JV interest breakdown of Partners P and S. In principle, the scheduling of radio resources may be such that the aggregate amount of resources committed to each of the Partners P and S is proportional to their interest in the JV.

According to aspects, a new bearer assigned to a specific partner may be admitted, despite causing a projected imbalance of RAN resource consumption in excess of that partner's interest. For example, when excess RAN resources committed to the remaining RAN sharing partners exist, and an overall spare capacity of RAN resources exist, a BS may admit a new bearer belonging to the specific partner desiring more RAN resources. Thus, despite causing a violation of RAN resource consumption based on the JV interest, the BS may flexibly allocate the excess resources to one or more partners in need.

During high traffic loads, scheduler decisions by BS 300 may result in occasionally not meeting quality of service (QoS) objectives for one or more bearers. The proportion between the partners in which such failure to meet QoS objectives occurs may be subject to the mutual agreement between the sharing partners, and may be communicated to the base station as a one-time or infrequent operation.

According to aspects, the shared BS may disproportionally apportion failed QoS incidents to a non-premium service provider. The premium service provider may be either a primary or non-primary partner. For example, either the primary or non-primary partner may provide service to high-value business customers. Therefore, the premium partner may negotiate a better QoS service level in the JV agreement, for example, by paying a higher premium. Conversely, a lower QoS service may be provided to a non-premium partner in exchange for a financial discount.

### Packet Queuing Principles

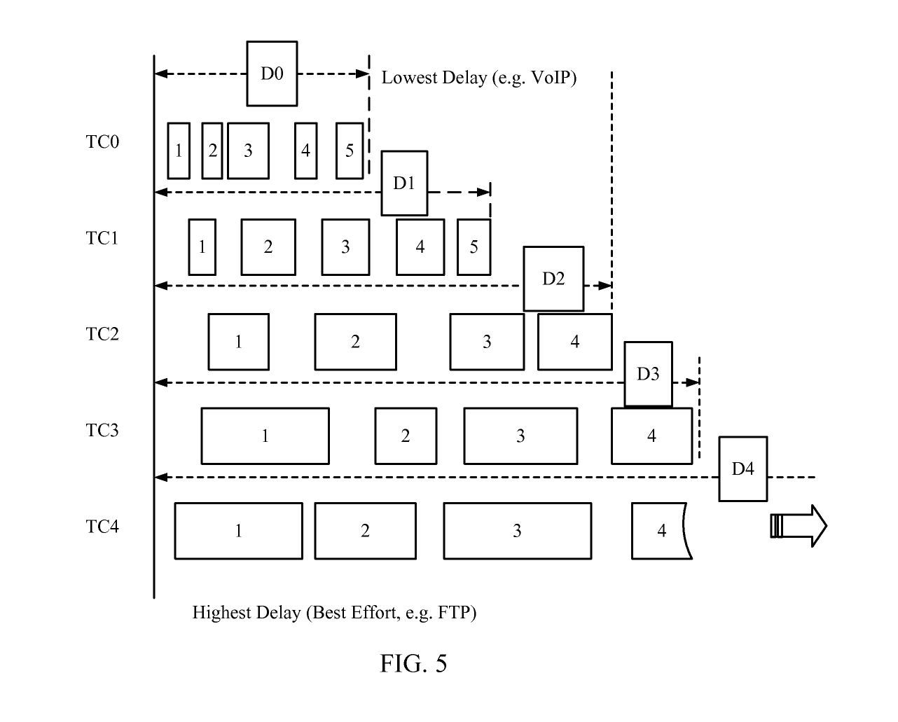

FIG. 5 illustrates an example of packet queuing principles involving multiple QoS classes for a non-shared RAN element. Queued packets, representing various radio bearers associated with a traffic class (TC) are illustrated. As time (illustrated on the x-axis) passes, packets move closer to their respective transmit time, as transmitted packets are removed from the queue.

As illustrated, each TC may have its own queue and tolerable delay (D). For example, traffic class 0 (TC0), which may correspond to a Voice over Internet Protocol (VoIP) transmission, has the lowest delay tolerance (D0) of TCs illustrated in FIG. 5. Traffic class 1 (TC1) has a higher delay tolerance D1 that TC0. Traffic class 2 (TC2) has a higher delay tolerance than TC1 and TC0, and traffic class 4 (TC4) has the highest delay tolerance (D4). As an example, TC4 may correspond to file transfer protocol (FTP) transmissions.

In a congested state, the queues in the BS may reach capacity. Thus, the time each packet spends in its respective queue may approach the delay tolerance for the corresponding TC.

### Bearer Admission Principles

RAN resources are fungible. For example, if there are many TC0 flows, BS 300 may allocate more resources to TC0 flows, at the expense of other TC flows. Over time, the BS may assess an average radio transmission resource required for each distinct TC. The BS may assess the spare capacity at any point in time by estimating how much additional traffic may be handled before all TC queues reach capacity (e.g., when any additional traffic will inevitably lead to violation of delay tolerance).

A BS may decide not to admit a newly requested bearer if the assessed resource requirement of the requested bearer may result in exceeding the spare capacity of the RAN resources. For example, if the spare capacity is 4%, the BS may not have enough resources to admit a high quality video streaming bearer estimated to require 6% of BS 300 capacity, but may be able to admit a telephony bearer estimated to require less than 1% of BS 300 capacity, without exceeding its spare capacity.

### Shared RAN Scheduler

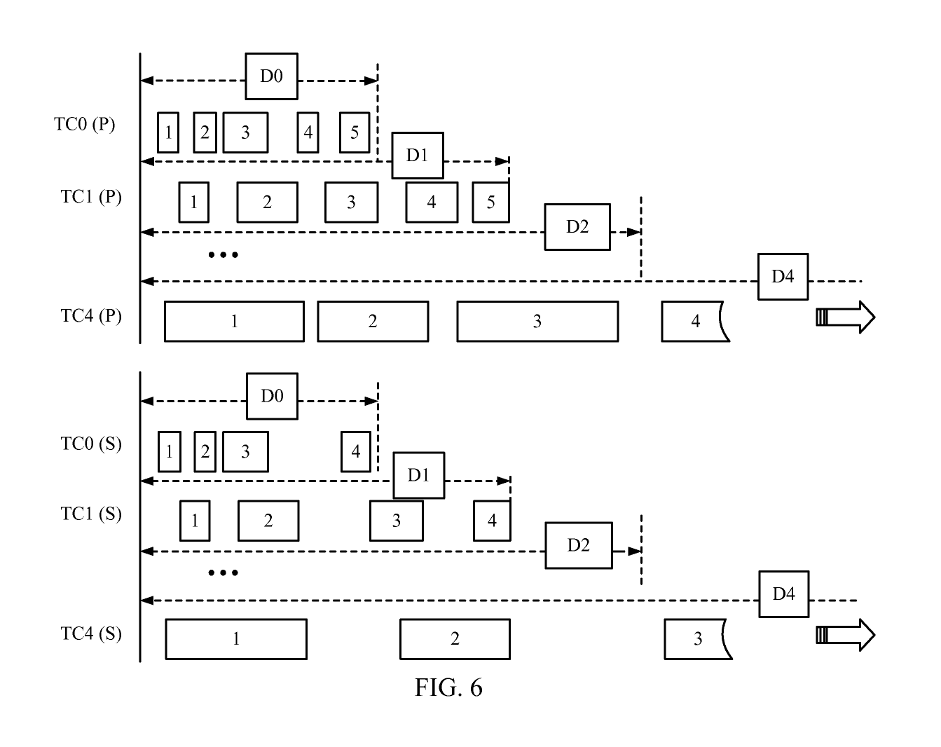

FIG. 6 illustrates an example of sharing RAN resources, according to aspects of the present disclosure. In a shared RAN arrangement, each of the sharing partners may have a set of radio bearers. In FIG. 6, two sets of radio bearers are illustrated, one set for Partner P and another set for Partner S. Although aspects presented herein are described and illustrated with reference to two RAN sharing partners, they may be applied to any number of partners.

Similar to FIG. 5, queued packets, representing various radio bearers associated with a TC are illustrated. As time passes, packets move closer to their transmit time.

Assuming that Partner P has a 60% majority share and Partner S has a 40% share in the shared RAN resources, the BS may maintain the 60/40 breakdown of transmission resources committed to each P and S flow. This is schematically reflected in FIG. 6, as the TC(S) packets are sparser as compared to the TC(P) packets. In other words, there are fewer packets in queues assigned to Partner S at any given time, but these packets may be waiting in queue for a same or a longer average time than packets belonging to Partner P.

The BS 300 may assess the excess capacity for each of the P and S flows. Additionally, the BS 300 may assess the overall spare capacity of its RAN resources.

According to aspects, the BS 300 may admit a new bearer for a specific partner if the overall capacity will not be exceeded by admission and if the capacity allocated to the specific partner will not be exceeded by admission. For the above example, a new P bearer may be admitted if the overall capacity of the BS will not be exceeded and if the required capacity for all P bearers will not exceed 60% of the total capacity of BS 300.

In an effort to flexibly allocate RAN resources, according to aspects, a new bearer assigned to a specific partner may be admitted, despite causing a projected imbalance of RAN resource consumption in excess of that partner's proportion interest. As described above, when an excess of RAN resources committed to the remaining RAN sharing partners exist and an overall spare capacity of RAN resources exist, a BS may admit a new bearer belonging to the specific partner.

According to aspects of the present disclosure, BS 300 may strive to schedule resources such that the traffic flows for all bearers do not exceed delay tolerances allowable for their class. Due to admission rules, on average, the volume of packets belonging to P and S flows may be 60/40. However, due to mobility effects and the random nature of services, this breakdown may not strictly hold in the short term.

According to aspects of the present disclosure, the BS 300 may keep a running average of transmission resources consumed for each partner. It may decide which packet to transmit next based on the time spent in queue and/or time remaining before exceeding a tolerable delay (D) for its TC. The BS may decide which packet to transmit next based on a rebalancing of running averages for queues of the partners. The BS may choose to transmit a packet with a lowest delay tolerance first, if the above criterion is satisfied.

### Erasing Packets

While admission control may reduce the probability of congestion, it may not completely eliminate it. The BS may handle congestion by deleting packets, thereby effectively reducing its workload.

According to aspects of the present disclosure, a BS may first delete packets with a longest delay tolerance first (e.g., TC4(P) and TC4(S) of FIG. 6). Alternatively, the BS may delete packets that can tolerate a degree of erasure with less amount of impact on the corresponding service. For example, deleting 1-2% of VoIP packets, well spaced between deletions may be transparent to an end user.

The BS may keep track of each time a packet needs to be erased, which may be termed a failed QoS incident. The BS may differentiate apportionment of failed QoS incidents between sharing partners. According to aspects of the present disclosure, the BS 300 may treat all failed QoS incidents equally, without regard to which of the sharing partners the packet belongs.

As another example, the BS 300 may apportion QoS failures to a non-primary Partner (S) first, before extending them to the primary Partner (P). Such differentiated apportionment of QoS failures may allow creative business arrangements between RAN sharing partners. For example, a non-primary Partner (S) can receive a discount for bearing the brunt of failed QoS incidents (e.g., packet erasures).

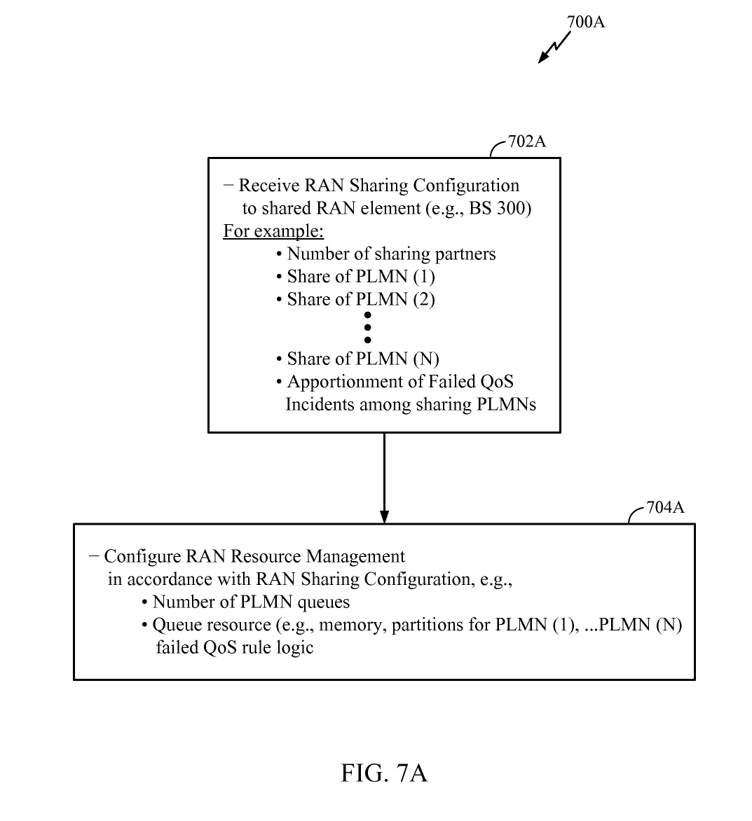

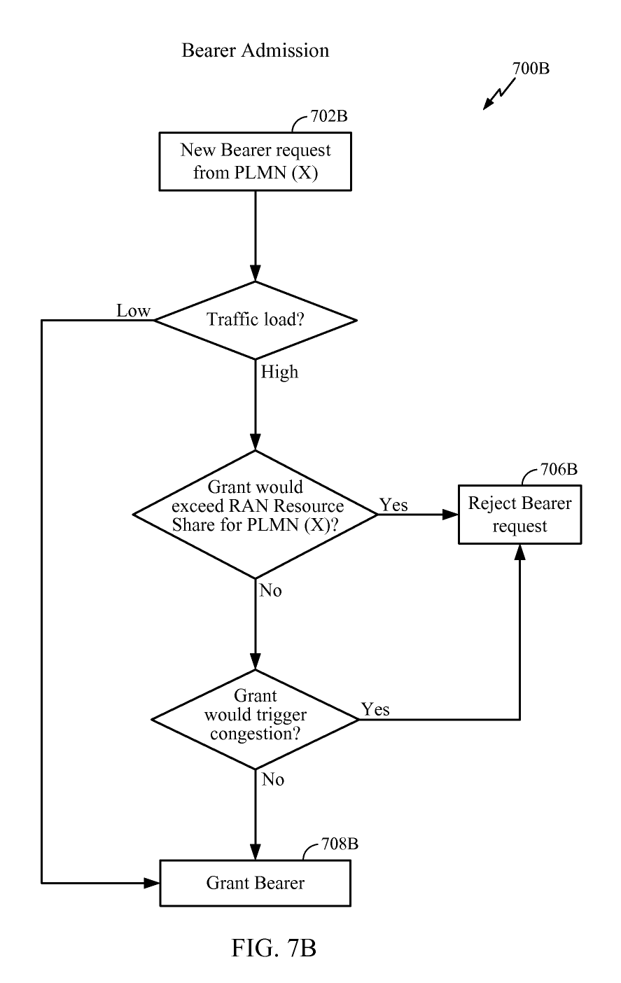

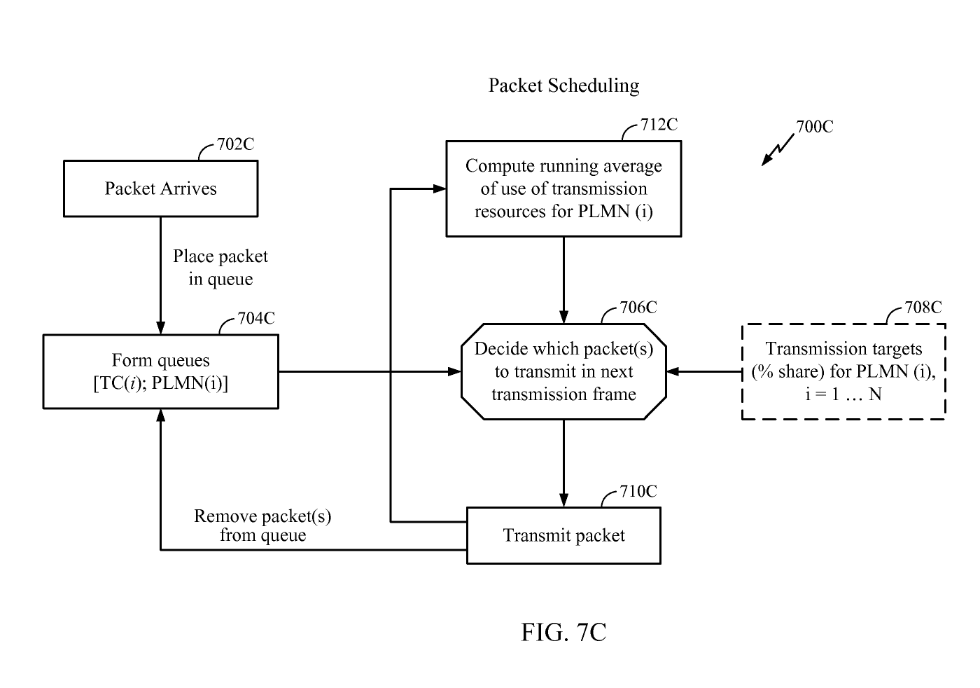

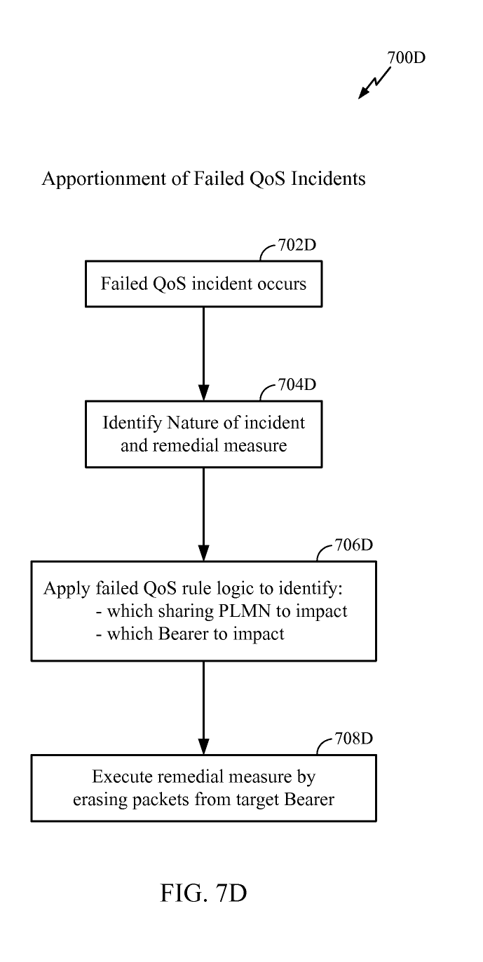

FIGS. 7A-7D illustrate one-time or infrequent operations and “operational” functions performed by the shared RAN element. As described herein, the RAN element may distinguish between one time and/or infrequent operations, including operations that reflect the specific sharing agreement between the partners (e.g., JV interest breakdown, how failed QoS incidents are handled) versus operations which are “operational” in nature (e.g., bearer admission and packet scheduling operations).

FIG. 7A illustrates example operations for determining a relationship between partners and configuring the RAN resource in accordance with the relationship, FIG. 7B illustrates example bearer admission operations, FIG. 7C illustrates example packet scheduling operations, and FIG. 7D illustrates example operations for apportioning failed QoS incidents, in accordance with aspects described herein.

FIG. 7A illustrates example operations 700A for determining a relationship between partners according to aspects of the present disclosure. According to aspects, at 702A, the shared RAN element (e.g., BS 300 of FIG. 3, BS 420 of FIG. 4) may receive an indication of the number of sharing partners (e.g., PLMNs) as well as relationship between the partners. For example, the RAN element may be instructed regarding the identity of PLMN1 and PLMN2, and breakdown in interest of the shared RAN resources (e.g., radio bearers) to each of the PLMNs, e.g., 60% to PLMN1, 40% to PLMN2. The shared RAN element may also be given instructions on how to apportion failed QoS incidents between the sharing PLMNs.

At 704A, the RAN resource element may be configured in accordance with the RAN sharing configuration. The RAN element may configure the number of PLMN queues needed. In addition, the RAN element may allocate and manage queue resources, including, for example, memory, partitions for each PLMN, and/or failed QoS rule logic.

FIG. 7B illustrates example operations 700B for bearer admission by a shared RAN element, according to aspects of the present disclosure. At 702B, the RAN element may receive a new bearer request from a PLMN. The RAN element may assess the traffic load in an effort to determine whether it should grant the new bearer request.

In the case of a low traffic load, the RAN element may, at 708B, grant the bearer. In the case of a high traffic load, the RAN element may determine if the grant would exceed the allocated RAN resource share for the requesting PLMN. If the grant would exceed the PLMN's share, according to aspects, the RAN element may, at 706B, reject the bearer request. While not illustrated in FIG. 7B, according to aspects, despite causing a potential violation of RAN resource consumption based on a JV interest, the BS may grant a new bearer to the requesting PLMN(x) if both an excess capacity of the RAN resources committed to the other PLMNs and an overall spare capacity of RAN resources exist.

Returning to FIG. 7B, if the grant would not exceed the PLMN's share of resources, the RAN element may determine if the grant would trigger congestion. If the grant would trigger congestion, the RAN element may, at 706B, reject PLMN's bearer request. If the grant would not trigger congestion, the RAN element, at 708B, may grant the request bearer.

FIG. 700C illustrates example operations 700C for packet scheduling by a RAN element, according to aspects of the present disclosure. At 702C, the RAN element may receive a packet and place the packet in queue. At 704C, the RAN element may form queues, for example, for each traffic class associated with each sharing PLMN. Queues are updated each time either a new packet arrives, or a packet is transmitted. At 706C, the RAN element may decide which packet to transmit during the next transmission frame.

According to aspects, the RAN element may decide which packet to transmit based on running averages. For example, at 708C, the RAN element may keep transmission targets according to the specific RAN sharing agreement for each PLMN to help determine which packet to transmit during the next transmission frame. The transmission targets in 708C are fixed percentage targets, which are set during the one-time or infrequent operation described in FIG. 7A.

After deciding which packet to transmit during the next transmission frame, the RAN element may, at 710C, transmit the selected packet. The transmitted packet may be removed from its respective queue. After transmitting the selected packet, the RAN element may, at 712C, compute running average of transmission resources for each PLMN. The cycle comprised of 706C, 710C, 704C (removal from queue), and 712C then repeats itself for each transmission frame.

FIG. 7D illustrates example operations 700D for apportionment of failed QoS incidents by a RAN element, according to aspects of the present disclosure. At 702D, the RAN element may detect a failed QoS incident. The RAN element may, at 704D, identify the nature of the incident and a remedial measure. At 706D, the RAN element may apply a failed QoS rule logic (e.g., based on a failed QoS logic rule received in FIG. 7A) to identify which sharing PLMN and which bearer the failed QoS incident should impact. At 708D, the RAN element may execute the remedial measure, for example, by erasing packets from the target bearer.

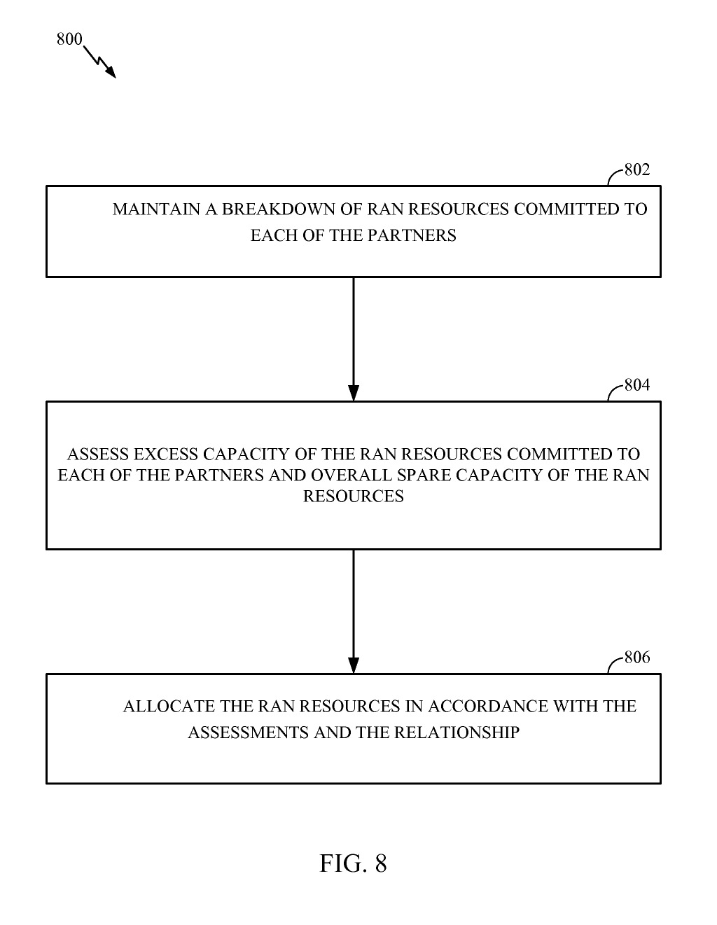

FIG. 8 illustrates example operations 800 for allocating (RAN) resources in accordance with a relationship between partners, according to aspects of the present disclosure. Operations 800 may be performed by a RAN element, such as a base station 420 of FIG. 4. At 802, the RAN element may maintain a breakdown of RAN resources committed to each of the partners. At 804, the RAN element may assess excess capacity of the RAN resources committed to each of the partners and overall spare capacity of the RAN resources. At 806, the RAN element may allocate the RAN resources in accordance with the assessments and the relationship.

As described herein, the RAN element may admit a radio bearer corresponding to a partner if an assessed resource requirement of the radio bearer does not exceed the overall spare capacity of the RAN resources and an excess capacity of the RAN resources committed to the one or more other partners. Assessing the overall spare capacity of the RAN resources may include estimating how much additional traffic can be handled until one or more traffic classes (TCs) of the resources reach maximum delay tolerance. As described herein, a radio bearer corresponding to a partner may be admitted if an assessed resource requirement of the radio bearer does not exceed the overall spare capacity.

Thus, aspects of the present disclosure provide methods and apparatus for RAN resource allocation pursuant to RAN sharing arrangements. As described herein, a RAN element may determine a relationship between partners (e.g., PLMNs). The relationship may define how shared RAN resources (e.g., radio bearers) are allocated between the partners. A BS may allocate RAN resources in accordance with the determined relationship between partners, an excess capacity of the RAN resources committed to each of the RAN sharing partners, and an overall spare capacity of the RAN resources.

In an effort to more effectively utilize RAN resources, at times, the resource allocation may be in violation of the RAN sharing agreement. As described herein, a first RAN sharing partner utilizing all of its allocated resources may be allocated additional resources when an excess capacity of RAN resources committed to one or more other partners exist and when and overall spare capacity of the RAN resources exist.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of allocating radio access network (RAN) resources in accordance with a relationship between partners, comprising:
maintaining a breakdown of RAN resources committed to each of the partners;
assessing excess capacity of the RAN resources committed to each of the partners and overall spare capacity of the RAN resources; and
allocating the RAN resources in accordance with the assessments and the relationship.

2. The method of claim 1, further comprising:
admitting a radio bearer corresponding to a partner if an assessed resource requirement of the radio bearer does not exceed the overall spare capacity of the RAN resources and an excess capacity of the RAN resources committed to the other partner.

3. The method of claim 1, further comprising:
determining the relationship between the partners that defines how the RAN resources are allocated by receiving a breakdown of interest of shared RAN resources from at least one of a network entity or one of the partners.

4. The method of claim 1, wherein the relationship between partners defines an asymmetric sharing of the RAN resources.

5. The method of claim 1, wherein
assessing the overall spare capacity of the RAN resources includes estimating how much additional traffic can be handled until one or more traffic classes (TCs) of the resources reach maximum delay tolerance.

6. The method of claim 5, wherein allocating the RAN resources comprises:
admitting a radio bearer corresponding to a partner if an assessed resource requirement of the radio bearer does not exceed the overall spare capacity.

7. The method of claim 1, wherein allocating the RAN resources based on the assessments and the relationship comprises:
determining which packet of a traffic class (TC) of the RAN resources to transmit to a wireless device.

8. The method of claim 7, wherein determining which packet of the TC to transmit comprises:
transmitting a packet of the RAN resources based on at least one of: a time the packet has spent in queue or a time remaining before the packet exceeds an allowable delay based on its traffic class (TC).

9. The method of claim 8, wherein determining which packet of the TC to transmit comprises:
transmitting a packet with a lowest delay tolerance.

10. The method of claim 1, wherein allocating the RAN resources based on the assessments and the relationship comprises:
determining which packet of a traffic class (TC) of the RAN resources to erase when a quality of service (QoS) constraint may not be met for all traffic flows of the RAN resources.

11. The method of claim 10, wherein determining which packet of a TC of the RAN resources to erase when a QoS constraint may not be met for all traffic flows of the RAN resources comprises:
erasing a packet with a longest delay tolerance.

12. The method of claim 10, wherein determining which packet of a TC of the RAN resources to erase when a QoS constraint may not be met for all traffic flows of the RAN resources comprises:
erasing a packet based on least impact on service of its corresponding TC.

13. The method of claim 10, further comprising:
apportioning a failed QoS incident based on the determined relationship between partners, wherein the determined relationship disproportionally apportions the failed QoS incident to a premium service provider.

14. The method of claim 13, wherein the premium service provider is a primary partner of the partners.

15. The method of claim 13, wherein the premium service provider is a non-primary partner of the partners.

16. An apparatus for allocating radio access network (RAN) resources in accordance with a relationship between partners, comprising:
means for maintaining a breakdown of RAN resources committed to each of the partners;
means for assessing excess capacity of the RAN resources committed to each of the partners and overall spare capacity of the RAN resources; and
means for allocating the RAN resources in accordance with the assessments and the relationship.

17. The apparatus of claim 16, further comprising:
means for admitting a radio bearer corresponding to a partner if an assessed resource requirement of the radio bearer does not exceed the overall spare capacity of the RAN resources and an excess capacity of the RAN resources committed to the other partner.

18. The apparatus of claim 16, further comprising:
means for determining the relationship between the partners that defines how the RAN resources are allocated by receiving a breakdown of interest of shared RAN resources from at least one of a network entity or one of the partners.

19. The apparatus of claim 16, wherein the relationship between partners defines an asymmetric sharing of the RAN resources.

20. The apparatus of claim 16, wherein
the means for assessing the overall spare capacity of the RAN resources includes estimating how much additional traffic can be handled until one or more traffic classes (TCs) of the resources reach maximum delay tolerance.

21. The apparatus of claim 20, wherein the means for allocating the RAN resources is configured to admit a radio bearer corresponding to a partner if an assessed resource requirement of the radio bearer does not exceed the overall spare capacity.

22. The apparatus of claim 16, wherein the means for allocating the RAN resources based on the assessments and the relationship is configured to determine which packet of a traffic class (TC) of the RAN resources to transmit to a wireless device.

23. The apparatus of claim 22, wherein determining which packet of the TC to transmit comprises:
transmitting a packet of the RAN resources based on at least one of: a time the packet has spent in queue or a time remaining before the packet exceeds an allowable delay based on its traffic class (TC).

24. The apparatus of claim 23, wherein determining which packet of the TC to transmit comprises:
transmitting a packet with a lowest delay tolerance.

25. The apparatus of claim 16, wherein the means for allocating the RAN resources based on the assessments and the relationship is configured to determine which packet of a traffic class (TC) of the RAN resources to erase when a quality of service (QoS) constraint may not be met for all traffic flows of the RAN resources.

26. The apparatus of claim 25, wherein determining which packet of a TC of the RAN resources to erase when a QoS constraint may not be met for all traffic flows of the RAN resources comprises:
erasing a packet with a longest delay tolerance.

27. The apparatus of claim 25, wherein determining which packet of a TC of the RAN resources to erase when a QoS constraint may not be met for all traffic flows of the RAN resources comprises:
erasing a packet based on least impact on service of its corresponding TC.

28. The apparatus of claim 25, further comprising:
means for apportioning a failed QoS incident based on the determined relationship between partners, wherein the determined relationship disproportionally apportions the failed QoS incident to a premium service provider.

29. The apparatus of claim 28, wherein the premium service provider is a primary partner of the partners.

30. The apparatus of claim 28, wherein the premium service provider is a non-primary partner of the partners.

31. An apparatus for allocating radio access network (RAN) resources in accordance with a relationship between partners, comprising:
at least one processor configured to:
maintain a breakdown of RAN resources committed to each of the partners;
assess excess capacity of the RAN resources committed to each of the partners and overall spare capacity of the RAN resources; and
allocate the RAN resources in accordance with the assessments and the relationship; and
a memory coupled to the at least one processor.

32. A computer-program product for allocating radio access network (RAN) resources in accordance with a relationship between partners, the computer-program product comprising a non-transitory computer-readable medium having code stored thereon, the code executable by one or more processors for:
maintaining a breakdown of RAN resources committed to each of the partners;
assessing excess capacity of the RAN resources committed to each of the partners and overall spare capacity of the RAN resources; and
allocating the RAN resources in accordance with the assessments and the relationship.
